(19) United States
(12) Patent Application Publication
(10) Pub. No.: US 2012/0125867 A1
(43) Pub. Date: May 24, 2012

(54) FLUSHABLE FILTER DEVICE

(75) Inventor: BRYAN ANDERSEN, Cincinnati, OH (US)

(73) Assignee: Delaware Capital Formation, Inc., Wilmington, DE (US)

(21) Appl. No.: 13/303,717

(22) Filed: Nov. 23, 2011

Related U.S. Application Data
(60) Provisional application No. 61/458,511, filed on Nov. 24, 2010.

(51) Int. Cl. B01D 29/66

(52) U.S. Cl. 210/791; 210/409

(57) ABSTRACT

A flushable filter for use in filtering water in a chemical dispensing system has a screen selectively placed in a water flow passage with water flowing from one side of the screen therethrough to a separate side and then to a filtered water outlet. In a flush mode, water is directed along and past the one side of the screen to flush filtrates therefrom and to a flush water discharge outlet.

### RELATED APPLICATION

Benefit of the filing date of Nov. 24, 2010 of U.S. provisional patent application Ser. No. 61/458,511 is claimed and that application is incorporated herein by reference as if fully set out and expressed herein.

### FIELD OF THE INVENTION

This invention relates to apparatus and methods for dispensing and mixing liquids, and more particularly to such apparatus and methods that dispense and mix chemicals, and even more particularly to dispensing and mixing cleaning chemicals sometimes found in and referred to as Janitorial Sanitation or as Jan-San industry, and to flushable filters used therein.

### BACKGROUND OF THE INVENTION

In the chemical mixing and dispensing field it is common practice for customers to purchase concentrated chemicals. Most of these concentrated chemicals are designed to be diluted with water. The product comprising the mix of concentrated chemical and water provides many useful applications related to the Janitorial Sanitation industry or Jan-San industry.

It is common that concentrated chemical, to achieve the designed dilution, needs to be diluted with a range of tens to several hundred units of water to one unit of chemical. To achieve this dilution ratio the chemical must be metered carefully using devices that commonly contain small orifices that control how much chemical can be mixed into the water, then dispensed into some container or bucket.

Considering this, care is taken by chemical manufacturers to control the amount and size of foreign debris in the concentrated chemical because debris or the accumulation of debris can adversely affect performance (i.e. mix ratios) in the dispensers. Therefore, for the same reasons, incoming water is commonly filtered to control the amount and size of foreign debris in the incoming water.

Most chemical dispensers in the Jan-San industry filter the incoming water with some sort of known filtering device like those from various manufacturers. The life span of the devices can depend on the condition of the incoming water. The water may contain more or less debris because of local water conditioning, plumbing, building age, or local construction.

Known filters and strainers are subject to inherent performance concerns.

For example, filters and particularly those with small screen areas are fast to clog. Moreover, many filters are located within a system housing or body blocking view of the filters and preventing casual visual inspections of the filter or screen conditions. Other systems cannot be disassembled to clean, such as those made of welded plastic construction. And some filters cannot be flushed for cleaning.

The current invention improves upon these deficiencies in prior devices in several ways.

### SUMMARY OF THE INVENTION

The current invention comprises a flushable filter apparatus including a combination of parts operably interconnected to flow water through a screen, in one mode, and to flow water past the upstream screen surface in another mode to flush it.

The invention contemplates a number of features and functions, including the following.

In one mode, inlet water is directed through a filter screen. In a flush mode, inlet water is directed across an upstream side of the screen flushing collected debris or filtrates therefrom.

In the single action “flushable” operation, a brass ball valve is opened to allow flushing the filter without any disassembly. This enables end users to easily and selectively flush the screen and maintain proper dispenser operation and desired mix ratios without the need of a service call or disassembly.

The brass ball valve is swiveled for either left to right or right to left for a variety of installations. This ball valve, when closed, functions to cause inlet water flow through the filter screens for filtration. When open, the ball valve allows inlet water to rush past and across the upstream screen surface, without flowing through the screen, flushing it of filtrates separated from prior water flow through the screen and discharging from a flush water outlet.

Preferably, the screen area is five times larger than certain current washer strainer or screen filters. Preferably, screen mesh size is 70, with openings in the screen at or about 0.0083″ or 10 microns.

A filter housing bowl is of clear material, making a visual inspection of the filter screen condition possible.

The bowl is preferably molded from a material marketed by a company named EMS-Chemie AG, Via Innovativa 1, CH-7013 Domat/EMS, Germany, under the mark “Grivory GTR 45”. This plastic is known for its chemical resistance, strength and clarity out of the mold. Any suitable material will suffice respecting burst pressure, clarity and any other desirable parameters.

Preferably, the base or apparatus housing is molded out of 15% glass filled Polypropylene (PP).

The inlets and outlets are threaded for ⅜″ NPT fittings.

A “clean” filter in the unit produces a low initial pressure drop equal to or less than 1 psi

In performance, the invention is capable of 680 dispensing hours before reaching a 5 psi pressure drop. Even though another 280 hours may be necessary to exceed the 5 psi drop, it is preferable that a flush cycle is conducted as soon as 5 psi drop is indicated.

### BRIEF DESCRIPTION OF THE DRAWINGS

FIG. 1 is an isometric view of the invention;

FIG. 2 is an illustration of the invention connected in a dispensing application;

FIG. 3 illustrates a dispensing mode flow path in cross-section of the invention of FIGS. 1 and 2;

FIG. 4 illustrates a flush mode flow path in cross-section of the invention of FIGS. 1 and 2;

FIG. 5 illustrates a washer strainer as used in water inlet;

FIG. 6 is an isometric view in cross-section view in a portion of FIG. 1; and

FIG. 7 is an isometric view in cross-section similar to FIG. 6 from a slightly closer perspective.

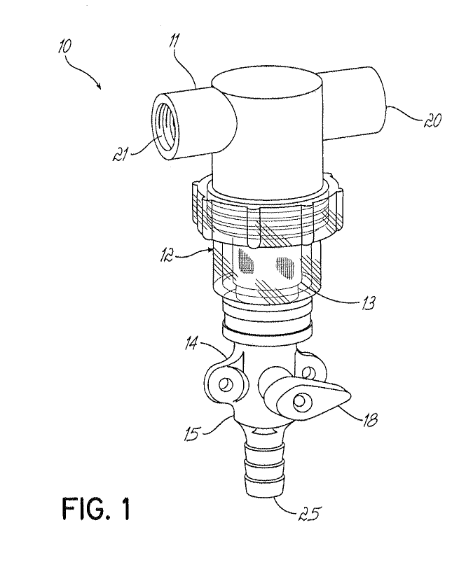

### DETAILED DESCRIPTION OF THE INVENTION

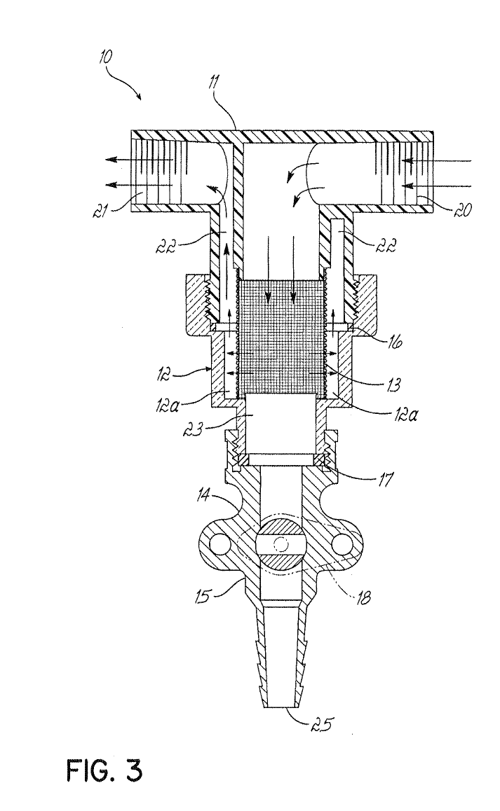

Turning to the FIGS., the flushable filter apparatus 10 of the invention includes a body or base 11, a filter or screen bowl 12 (preferably transparent), a screen-type filter 13 as described above and a valve, preferably a ball valve 14, preferably brass, in a ball valve housing 15. Gaskets 16, 17 best seen in FIGS. 3, 4, 6 and 7, provide seals between body 11 and bowl 12, and between bowl 12 and ball valve housing 15.

The ball valve 14 is disposed in housing 15 and is manually operable by a handle 18.

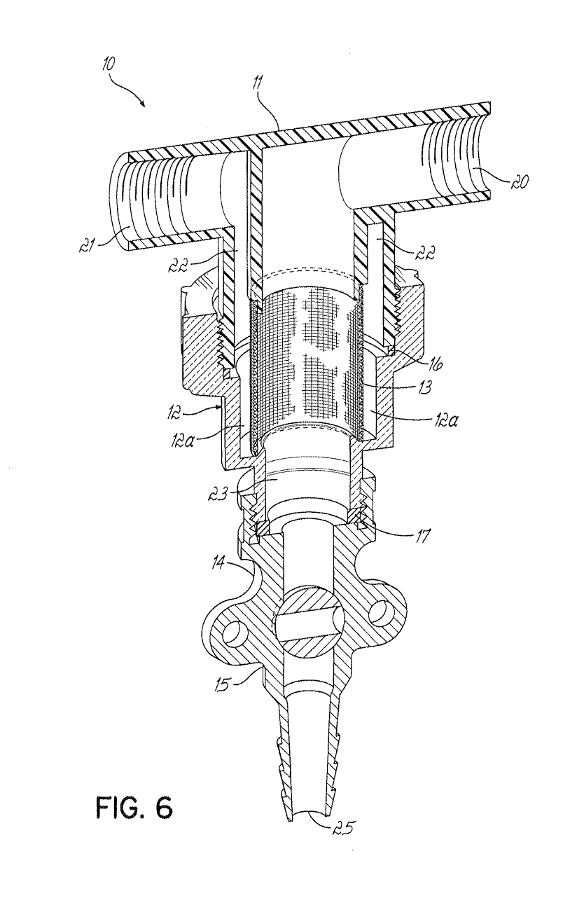

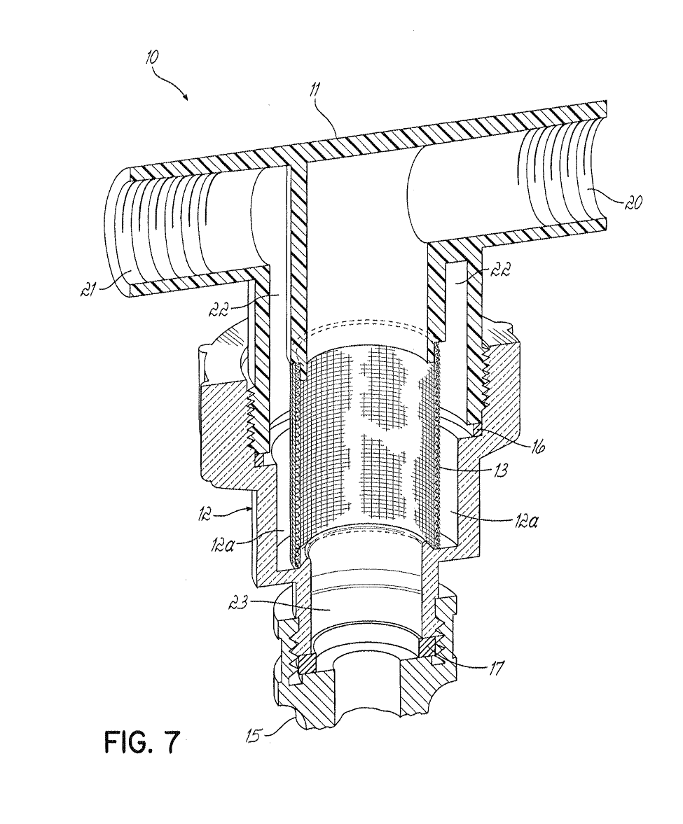

The internal features of apparatus 10 are best seen in FIGS. 6 and 7.

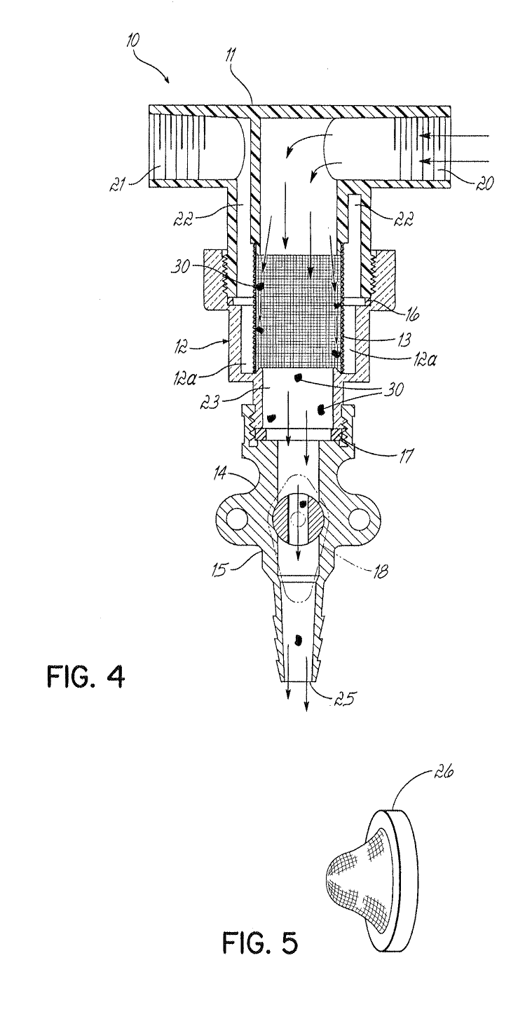

The apparatus 10 includes a water inlet 20, a water flow outlet 21 and a water flow passage 22. Bowl 12 has a lower water outlet 23 (FIG. 4) operably open to downstream ball valve housing 15.

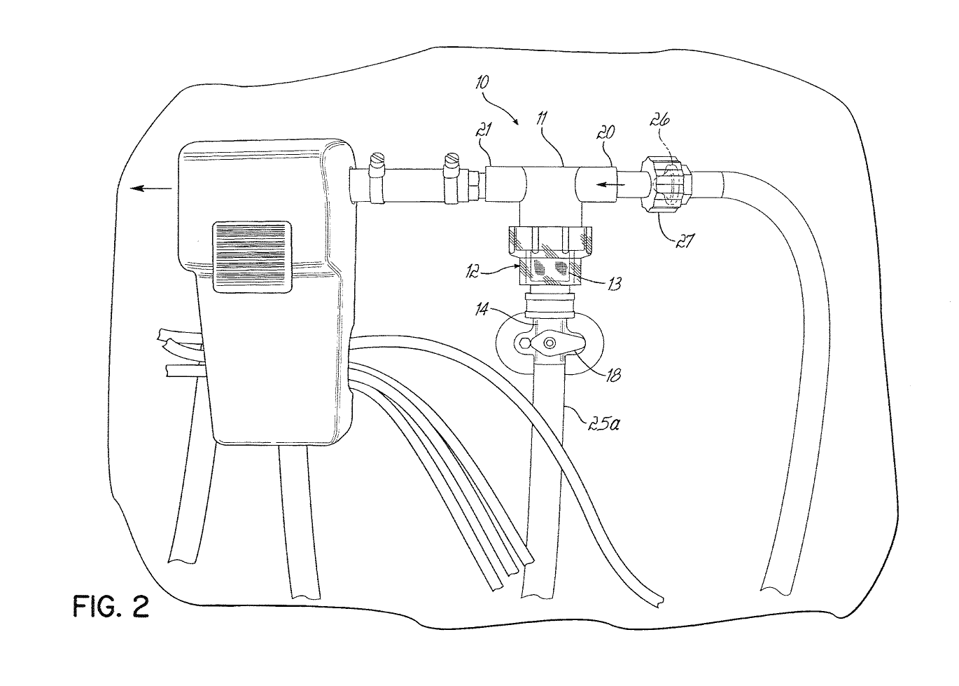

FIG. 2 illustrates flushable filter apparatus 10 connected to a water source hose at inlet 20 and to a chemical dispenser as shown at outlet 21 in FIG. 2.

In FIG. 3, ball valve 14 is closed to water flow through housing 15. Flushable filter apparatus 10 is thus set to filter water flow from inlet 20, through filter 13 in bowl 12, through passage 22 and to outlet 21.

In FIG. 4, ball valve 14 in housing 15 is open to water flow from inlet 20, through bowl 12 and past the interior surface of filter 13 to outlet 23, through the ball valve and housing 15 to a flush water discharge 25 and discharge tube 25a (FIG. 2) and thus to flush filter 13.

FIG. 5 illustrates a common in line screen filter 26 which can be used outside of flushable filter apparatus 10. One such location could be within in-line connector 27 just prior to fluid inlet 20 shown in FIG. 2.

It will thus be appreciated that when ball valve 14 is closed, as in FIG. 3, water from inlet 20 flows into the interior of screen filter 13, through that screen from an interior to an exterior outside thereof and into the space 12a in bowl 12 around the outside of annular screen 13, and operably communicating with passage 22 to filtered water flow outlet 21.

On the other hand, when valve 14 is open to flow water therethrough (as in FIG. 4), water from inlet 20 flows into the interior of filter screen 13, washing the inside surface of the filter 13 and flowing through outlet 23, through valve 14 and to flush water discharge 25, carrying with it foreign debris 30 previously filtered out of the dispensing or filtered water flow by and onto the interior surface of the screen filter 13.

It will be appreciated that the flushing water flow past or across the interior or upstream side of screen 13 during flushing is faster (FIG. 4) than the water flow through filter 13 for dispensing filtered water (FIG. 3), primarily due to the flow path restriction represented by the flow path structure during normal dispensing. Accordingly, normal dispensing flow (FIG. 3) is at lower pressure, lower speed but higher volume than the higher pressure, higher speed and lower volume of the flush flow (FIG. 4).

Apparatus 10 thus presents use of the flush water through flush water discharge 25 as a regular water outlet, and provides a very short effective flush duration.

Moreover, it will be appreciated that the arrows of FIG. 3 illustrate filtered dispensing flow while the arrows in FIG. 4 illustrate flushing flow.

Also it will be appreciated that after a flush cycle removes debris from the screen, an open valve 14 provides a water outlet 25 source of fresh water.

Accordingly, the invention provides a flushable filter for water flow in a chemical dispensing apparatus wherein the filter is visible to an operator, and is easy to clean via a user-activated valve with flush water at higher pressure and velocity than the filtered water flow to facilitate and enhance the cleaning or rinsing process and to reduce the duration of the flush cycle.

What is claimed is:

1. A flushable filter apparatus including:
a water inlet;
a filtered water outlet;
a flush water outlet;
a filter bowl;
a filter within said bowl and having interior and exterior surfaces, said bowl having a bowl outlet communicating with an interior surface of said filter; and
a valve operably connected between said outlet of said bowl and a flush water outlet,
said valve, when open, allowing water flow from said inlet past an interior surface of said filter and through said flush water outlet and when closed, blocking water flow from said bowl outlet wherein water from said inlet flows through said filter to said filtered water outlet.

2. A flushable filter apparatus as in claim 1 including a water flow passage operably communicating with a portion of said bowl, spaced outwardly from an exterior surface of said filter and operably communicating with said filtered water outlet.

3. A flushable filter apparatus comprising:
a water inlet;
a filtered water outlet;
a filter having upstream and downstream sides;
a water flow path from said inlet through said filter and to said outlet,
a filter bowl including a flush water outlet, and
a second water flow path from said inlet past an upstream side of said filter to said flush water outlet distinct from said filtered water outlet.

4. An apparatus as in claim 3 further including a valve operably disposed between said bowl outlet and said flush water outlet for selectively opening and closing said second water flow path.

5. A method of providing filtered water to a chemical proportioner and of selectively flushing the filter, including the steps of:
flowing water from an interior surface portion of a filter through said filter;
collecting filtrates on said surface;
flowing filtered water to a first outlet connected to said proportioner;
selectively flowing water across said interior surface portion and flushing filtrates therefrom; and
discharging water and filtrates through a second outlet.

6. A method as in claim 5 including flowing filtered water to said first outlet at a first pressure at a first velocity and a first volume; and
flowing flush water past said filter interior portion at a second pressure higher than said first pressure;
at a second velocity higher than said first velocity and in a second volume lower than said first volume.
